(19) United States
(12) Patent Application Publication
(10) Pub. No.: US 2011/0061244 A1
(43) Pub. Date: Mar. 17, 2011

(54) Spooled cutting string for string trimmer

(76) Inventors: Larry Wood, Dalton, GA (US); Ed Ledford, LaFayette, GA (US)

(21) Appl. No.: 12/807,552

(22) Filed: Sep. 8, 2010

Related U.S. Application Data
(63) Continuation of application No. 11/006,024, filed on Dec. 7, 2004, now abandoned.
(60) Provisional application No. 60/527,348, filed on Dec. 8, 2003.

(51) Int. Cl. A01D 34/416

(52) U.S. Cl. 30/347

(57) ABSTRACT

A novel abrasive cutting string for use in a string trimmer provides for a thermoplastic string with abrasives in the surface, but not in the central core of the string, the string being wound on a spool for rotation and incremental extension of at least one extremity in combination with the operation of the string trimmer.

The present application is a continuation of U.S. Ser. No. 11/006,024, filed Dec. 7, 2004 which in turn claims priority of U.S. Provisional Application No. 60/527,348 filed Dec. 8, 2003, which is incorporated herein.

### FIELD OF THE INVENTION

This invention relates generally to an improved cutting string, and more particularly, to an improved cutting string for cutting grass, weeds and the like when mounted on a spool in combination with a rotary string trimmer.

### BACKGROUND OF THE INVENTION

It is known to use extruded nylon thermoplastic string such as of nylon to cut grass, weeds and the like in combination with a rotary string trimmer. Conventional thermoplastic strings, however, suffer from several disadvantages. For example, conventional strings have a substantially smooth exterior surface. More particularly, the exterior surface of conventional strings is devoid of any abrasive or aggregate materials which produce cutting surfaces. Instead, conventional strings rely on the rotational velocity and impacting force of the string to cut weeds, grass and the like. This, however, is an inefficient way to cut grass, weeds and the like. In addition, the smooth surface of conventional strings is devoid of any air voids which cool the string when it is rotated. As a result, conventional strings are known to melt and fuse in the head of a rotary string trimmer under normal or high temperature conditions. This results in costly and time-consuming repairs and requires frequent replacement of conventional strings.

Further, the cross-sectional shape of conventional strings is circular. Consequently, conventional strings do not have any edges or raised profiles which improve cutting efficiency, and instead they rely on the rotational velocity and impacting force of the string to cut grass, weeds and the like. As noted above, this is an inefficient way to cut grass, weeds and the like. Still further, as a result of the high rotational velocity and composition of conventional strings, they are susceptible to damage and breaking, and thus they have a limited lifespan. Finally, because conventional strings are inefficient (e.g., they rely upon the rotational velocity and force of impact of the string rather than any cutting surfaces on the string), they impart undue stress upon the rotary string trimmer with which they are used.

Some attempts have been made to improve upon conventional circular strings used to cut grass, weeds and the like in combination with a rotary string trimmer. For example, cutting strings have been extruded in different cross-sectional shapes. More particularly, the circular cross-sectional shape of conventional strings has been modified to a cross-sectional shape having one or more edges or raised profiles such as an octagon. This modification of conventional strings, however, also suffers from many of the same disadvantages as conventional strings of circular cross-section. Like conventional strings having a circular cross-sectional shape, conventional strings having a cross-sectional shape with raised profiles or edges have a generally smooth exterior surface. Consequently, conventional strings having a cross-sectional shape with raised profiles or edges still rely substantially on the rotational velocity and impacting force of the string to cut, and the result is an inefficient way to cut grass, weeds and the like.

Further, like conventional smooth surface circular strings, conventional smooth surface strings having a cross-sectional shape with raised profiles or edges are susceptible to melting and fusion in the head of the rotary string trimmer under normal or high temperature conditions. Again, this results in costly and time-consuming repairs and frequent replacement of the string. Still further, like conventional strings having a smooth, circular cross-section, conventional strings having a smooth, cross-sectional shape with raised profiles or edges have a limited lifespan due to the composition of the string and the high rotational velocity of the string. Finally, because conventional strings having edges or raised profiles are inefficient for cutting purposes inasmuch as they rely upon the rotational velocity and force of impact of the string rather than cutting surfaces on the string, they impart undue stress on the rotary string trimmer with which they are used.

In an effort to overcome these shortcomings, some attempts have been made to mix abrasive particles with thermoplastic resins to produce string. These attempts generally are very taxing on string extrusion equipment, tend to leave most of the abrasive particles buried in the string, and have abrasive particles even in the core of the string. The result is a relatively weak or breakable string without substantial external abrasive particle cutting surfaces. Alternatively, gluing abrasives to the string also results in difficulties in manufacturing and string performance.

It would be desirable, therefore, if an improved cutting string could be provided for cutting grass, weeds and the like when mounted upon a spool in combination with a rotary string trimmer. It would also be desirable if such an improved cutting string could be provided that would resist melting and fusion under normal or high temperature conditions. It would be further desirable if such an improved cutting string could be provided that would be less time-consuming and less expensive to maintain, repair and replace. It would be still further desirable if such an improved cutting string could be provided that would have a longer lifespan. It would also be desirable if such an improved cutting string could be provided that would reduce the stress imparted upon the rotary string trimmer with which it is used. It would be further desirable if a simple and inexpensive method for making such an improved cutting string could be provided.

Accordingly, it is an advantage of the invention described herein to provide an improved cutting string for cutting grass, weeds and the like when mounted upon a spool in combination with a rotary string trimmer. It is also an advantage of the invention to provide an improved cutting string that resists melting and fusion under normal or high temperature conditions. It is a further advantage of the invention to provide an improved cutting string that is less time-consuming and less expensive to maintain, repair and replace. It is a still further advantage of the invention to provide an improved cutting string with a longer lifespan. It is another advantage of the invention to provide an improved cutting string that reduces the stress imparted upon the rotary string trimmer with which it is used.

It is a yet another advantage of the invention to provide a simple and inexpensive method for making such an improved cutting string.

Additional advantages of the invention will become apparent from an examination of the drawings and the ensuing description.

### SUMMARY OF THE INVENTION

The invention comprises a cutting string for cutting grass, weeds and the like for mounting upon a spool for incremental unwinding in combination with a rotary string trimmer. The preferred cutting string is composed of a plastomeric material and comprises abrasives which are embedded on the string. The abrasives are preferably embedded on the cutting string by heating the abrasive and applying the abrasive with pressure onto the exterior surface of the string. Also in a preferred embodiment, the cutting string is exposed to an acidic substance that softens the string such that the abrasives may be embedded on the string.

A method is provided for making the improved cutting string. More particularly, the preferred method comprises the steps of extruding a plastomeric cutting string, exposing the cutting string to a heated abrasive such as sand, and cooling the cutting string and abrasive combination. In a preferred method, the extruded cutting string is exposed to an acidic substance adapted to soften the cutting string before the cutting string is exposed to the abrasive.

In another preferred embodiment, the extruded cutting string may be heated before it is exposed to the abrasive.

In order to facilitate an understanding of the invention, the preferred embodiments of the invention are illustrated in the drawings, and a detailed description thereof follows. It is not intended, however, that the invention be limited to the particular embodiments described or to use in connection with the apparatus illustrated herein. Various modifications and alternative embodiments such as would ordinarily occur to one skilled in the art to which the invention relates are also contemplated and included within the scope of the invention described herein.

### BRIEF DESCRIPTION OF THE DRAWINGS

The presently preferred embodiments of the invention are illustrated in the accompanying drawings, in which like reference numerals represent like parts throughout, and in which:

FIG. 1 is a partial cross-sectional view of a preferred embodiment of the cutting string in accordance with the present invention.

FIG. 1A is an enlarged view of the circled portion of the preferred cutting string illustrated in FIG. 1.

FIG. 2 is a schematic diagram of a preferred embodiment of the method for making the preferred cutting string in accordance with the invention.

FIG. 3 is a schematic diagram of an alternative embodiment of the method for making the preferred cutting string in accordance with the invention.

FIG. 4 is a sectional view of a prior art string trimmer spool mounted in a cutting head.

### DESCRIPTION OF THE INVENTION

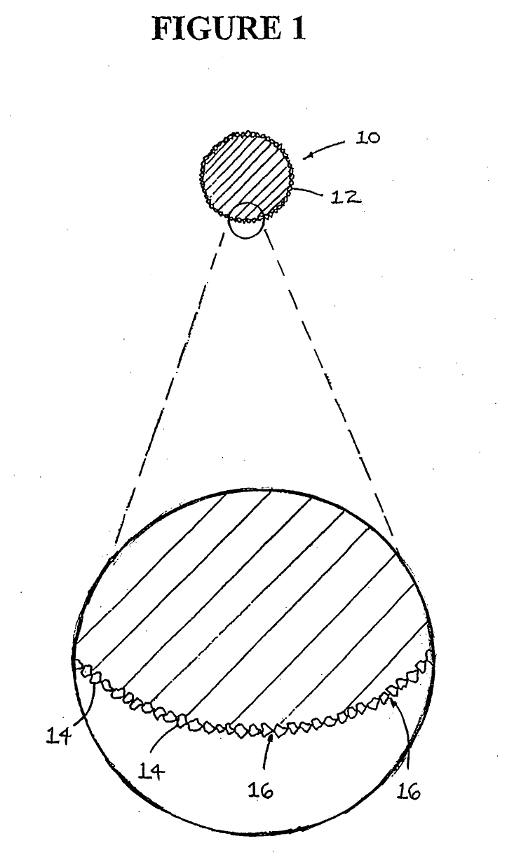

Referring now to the drawings, an exemplary apparatus and methods for making the apparatus of the invention are illustrated by FIGS. 1 through 4. As shown in FIG. 1, the cutting string is designated generally by reference numeral 10. The cutting string 10 is composed of a plastomeric material such as nylon that is extruded to have a substantially circular cross-sectional shape. It is contemplated within the scope of the invention, however, that cutting string 10 may be composed of any suitable material that may be formed into a string-like configuration. Further, it is contemplated within the scope, of the invention that cutting string 10 may be formed to have any suitable cross-sectional shape such as oval, crescent, semi-circular, triangular, square, rectangular, pentagonal, hexagonal, octagonal or any other polygonal shape. It is further contemplated within the scope of the invention that cutting string 10 may be produced by a process other than extrusion such as molding or any other suitable process for producing string.

Still referring to FIG. 1, cutting string 10 includes a plurality of abrasives 12. Abrasives 12 are preferably composed of very fine foundry sand or some other similar material such as very fine aggregates and the like. Abrasives 12 are attached to cutting string 10. Preferably, abrasives 12 are partially embedded on the exterior surface of cutting string 10. Also in the illustrated embodiment, abrasives 12 cover the substantially entire exterior surface of cutting string 10. Abrasives 12 are adapted to produce a non-smooth surface on the exterior of the cutting string. As shown in FIG. 1A, the non-smooth surface produced by abrasives 12 produces a plurality of cutting surfaces 14. The plurality of cutting surfaces improves the cutting efficiency of the cutting string as compared to conventional smooth surface strings.

As a result of cutting surfaces 14, cutting string 10 need not be rotated at the same high velocity as conventional smooth surface strings in order to cut the same grass, weeds and the like. Further, cutting string 10 having cutting surfaces 14 reduces the amount of stress imparted upon the rotary string trimmer with which it is used because of its improved cutting efficiency. Still further, the abrasives on cutting string 10 permit the string to cut through larger, thicker and denser objects than conventional smooth surface strings. In experiments conducted to date, it has been found that preferred cutting string 10 with abrasives 12 is capable of cutting objects up to ten times larger than conventional smooth surface strings and up to forty percent (40%) faster than conventional smooth surface strings.

Abrasives 12 produce another advantage. As shown in FIG. 1A, the abrasives produce a non-smooth surface which results in a plurality of air voids 16 in the trimmer head coil. Air voids 16 cool cutting string 10 as it rotates, thereby reducing the temperature of the cutting string and inhibiting melting and fusion of the cutting string.

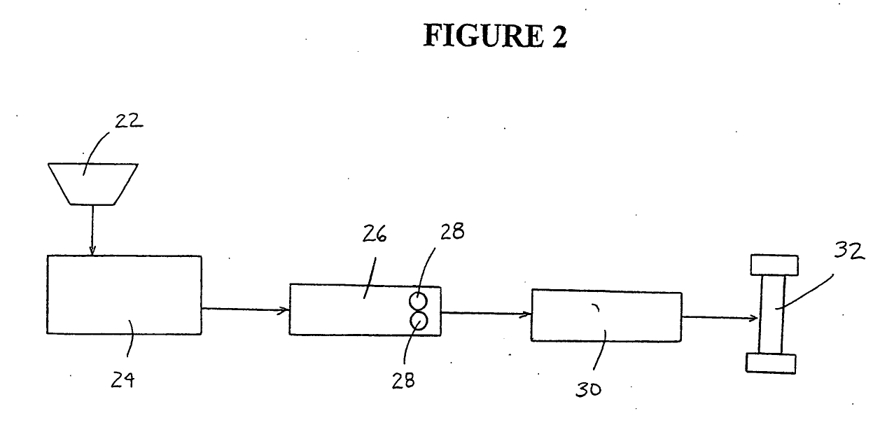

Referring now to FIG. 2, a method of making cutting string 10 is illustrated. More particularly, as shown in FIG. 2, the method of making cutting string 10 includes the steps of feeding nylon pellets into hopper 22, which are melted and extruded in the form of cutting string 10 by extruder 24. As discussed above, nylon or any other suitable plastomeric material may be used to produce the cutting string. Further, as discussed above, cutting string 10 may be extruded by extruder 24 or any other suitable method or device for producing a cutting string.

Still referring to FIG. 2, the method also includes the step of exposing the cutting string to an abrasive material such as very fine foundry sand. According to this method, the cutting string is placed into super heated sand bath 26 where the sand is heated, and the heated sand is applied to the cutting string under pressure using sand covered rollers 28. The heating of the string is sufficient to soften the external surface layer, but not so intense as to compromise the strength of the core of the string. As discussed above, the abrasive may be very fine foundry sand or any other suitable fine aggregate material that will produce a non-smooth surface, including a plurality of cutting surfaces and air voids, around the exterior surface of the cutting string. It is further contemplated within the scope of the invention that the abrasives may be applied to the cutting string by any suitable means for attaching the abrasives to the cutting string such as adhesives and the like.

Still referring to FIG. 2, the method also includes the steps of cooling the cutting string in cooling bath 30 and winding the cutting string onto storage reel 32 for storage. Cooling bath 30 preferably contains water or any other suitable coolant, but it is also contemplated that the string may also be cooled by means other than a cooling bath such as cooled air, liquid coolant sprayed on the string, ice or some other solid form of coolant, and the like. It is also contemplated within the scope of the invention that the cutting string may be stored in any suitable manner using any suitable storage device.

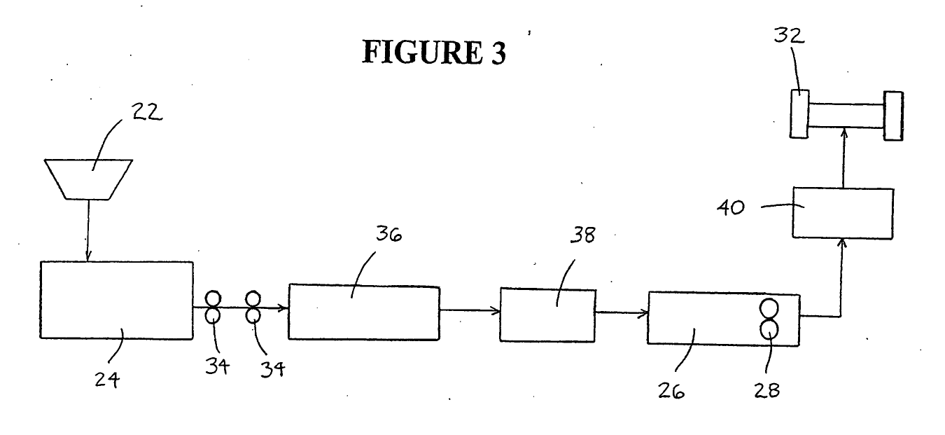

Referring now to FIG. 3, an alternative embodiment of the method of the invention is illustrated. More particularly, according to the alternative embodiment, after the extruding step described above, the cutting string is stretched by stretching rollers 34. It is contemplated within the scope of the invention, however, that the string may be stretched by any suitable device for stretching string. The stretched cutting string is then exposed to water or some other suitable coolant in cooling bath 36 in order to cool the string. It is contemplated within the scope of the invention, however, that the string may cooled by any suitable means such as cooled air, a sprayed liquid coolant, ice or the like or by using any suitable cooling device.

Still referring to FIG. 3, the cutting string is then exposed to an acidic substance such as hydrochloric acid (HCl), muriatic acid or the like in softening bath 38 to soften the external layer of the string. While as described the cutting string is placed into softening bath 38, it is contemplated within the scope of the invention that the acidic substance may be applied to the cutting string in any suitable manner by any suitable device. The softening is focused on the external layer of the string, and the string core is not compromised. The softened cutting string is then exposed to an abrasive material as described above. Next, the cutting string is exposed to water or some other rinsing agent adapted to substantially remove the acidic substance from the cutting string. While the string is preferably placed into rinsing bath 40 for the purpose of substantially removing the acidic substance from the string, it is contemplated within the scope of the invention that the acidic substance may be substantially removed from the cutting string by any suitable rinsing agent and by using any suitable rinsing device.

Finally, the cutting string is wound onto storage reel 32 for storage. It is contemplated within the scope of the invention that the cutting string may be stored in any suitable manner using any suitable storage device.

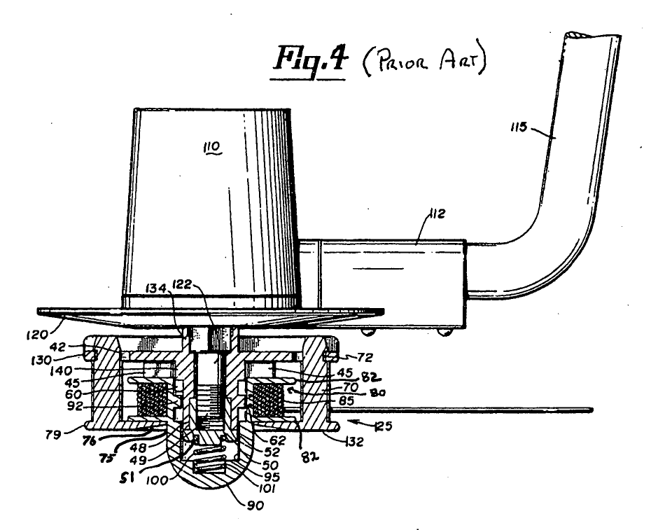

As shown in FIG. 4, a typical prior art rotary cutting assembly with cutting string feed is normally mounted on and driven by a suitable drive unit indicated generally at 110. The drive unit may be an electric or gasoline motor, the housing of which is coupled through a sleeve member 112 to a suitable support handle 115 for positioning the cutting assembly in the cutting of weeds. A suitable annular bumper 120 extends from the base of the housing and a drive shaft 122 extends therefrom to mount the rotary cutting assembly which is indicated generally at 125. The details of the drive assembly and the support or handle structure may take varying forms.

The rotary cutting assembly is comprised of a driven member having first and second plate members 130 and 132 respectively. Plate member 130 has a cylindrical hub 134 projecting from one surface thereof through which the drive shaft 122 extends. This surface of the plate member advantageously has a plurality of extending radial fins which, upon rotation, will provide cooling for the assembly. The plate member 130 has a second cylindrical hub portion 140 extending from the opposite surface with a cylindrical aperture therethrough concentric with the aperture of the hub portion 134 and receiving the extremity of the shaft 122. In addition, plate member 130, has a pair of elliptical apertures 42 therein and a plurality of posts 45 extending from the surface of the plate member opposite the radial fins. The plate member 130 is mounted on the drive unit 110 through the shaft 122 thereof. The shaft extends through the hub 134 and into hub 140 in a recessed portion 48 therein wherein a threaded extremity 49 of the drive shaft is located. A retainer flange 50 having an internal threaded surface or threaded recess is positioned in the recessed portion 48 of the hub 140 and threaded onto the threaded extremity of the shaft with a collar portion 52 bearing against the end of the hub 140 to retain the hub and the plate member 130 on the end of the shaft.

The hub 140 has an outer peripheral surface with an annular flange portion adjacent the plate member 130 which portion, as will be later noted, serves as a guide surface. The lower extremity of the hub is recessed from this guide surface and a plurality of triangular shaped teeth members 60 and 62 are distributed about the periphery of the same. Teeth members 60 are distributed along a common plane adjacent the annular flange guide surface and have a height equal to the external dimension or surface of the guide surface of the hub. These teeth or ratchet means are angularly spaced about the peripheral surface of the hub and the number of teeth may be varied, for purposes of determining the amount of cutting string to be incrementally fed from the storage spool within the driven member. A second set of teeth 62 are disposed in a plane parallel to and spaced from the plane of the teeth 60 and angularly distributed so that they are positioned radially in between the teeth 60 and equidistantly spaced having the same angular spacing peripherally on the hub.

The outer plate member 132, has a pair of post members 70 projecting therefrom with notched surface 72 in the extremity of the same. Plate member 132 has a central aperture 75 therein with an external dished surface 76 leading to the same. The posts 45 of plate member 130 have wear sleeves positioned over the same which act as spacers to space the plate member 130, 132 apart with the posts 70 having the notched extremities 72 extending through the apertures 42 in the plate member 130 and locking the same to the plate member 130. The plate member 132 around the post members 70 is slightly deformable such that the notched surfaces may be moved into and out of the apertures 42 for assembly and release of the plate members. These plate members of the driven member define a spaced area therebetween in which there is positioned the spool 80 which mounts the cutting string 85 of the rotary cutting assembly. Although not specifically shown, one or more strands of cutting string may be wound on the spool and secured to the hub of the same with the opposite extremity or extremities extending from the spool to provide the cutting surface conventional with a rotary cutting assembly of this type. Where two or more such lines are used, they will be wound in the same direction, but coming out through the posts 45 equidistantly spaced such that upon a predetermined relative rotation of the spool to the driven member, the lines will be unwound from the spool and extend out of the driven member. Except for the posts 45 and 70 the area between the plates 130 and 132 is open to expel dirt from the housing through centrifugal force. The plate 132 extends beyond the posts 45 and 70 to form a lip 79 which prevents the line from shearing off near the posts.

As will be seen in FIG. 4 the spool 80 is formed in a conventional manner with a pair of spaced sides 82 held together by a common hub portion and in the illustrated embodiment, has a hemispherically shaped hub member 90 formed integral therewith and projecting from one side of the spool. The interior of the hub portion of the spool has a plurality of projecting triangular teeth members 92 distributed about the inner periphery of the same. The interior of the hub has a recessed shoulder portion 95 which fits over the end of the hub 140 with the retaining flange 50 thereon to be guided thereon for longitudinal movement of the spool in an axial direction relative to the hub 140. Positioned between the interior of the hub 90 and the retainer flange 50 is a spring member 100 which fits into a recessed surface 51 in the retaining flange 50 and into a recessed surface 101 in the top of the hub 90. The spring is a compression spring which will bias the hub and hence, the spool 80 formed integral therewith, relative to the hub 140 such that the surface of the spool will bear against the plate 132. However, when the hub 90 is engaged by a surface, such as by depressing the hub against a solid surface, the spring 100 will be compressed allowing the hub 90 with the spool 80 integral therewith to slide on the hub 140 through the guiding surfaces on the respective hubs to permit the teeth 92 to disengage from the row of teeth 62 on the hub 140. With the driven member rotating, a relative rotation will take place between the spool 80 and the hub 140 or the parts of the driven member allowing the spool to rotate until the flat surfaces of the teeth 92 next to adjacent teeth 60 are engaged. Once the pressure on the spring is released by withdrawal of the hub 90 from the solid surface, the compression of the spring will move the spool 80 back towards the plate member 132 disengaging the teeth 92 from the teeth 60 and allowing them to engage with the teeth 62 on the hub 140. This will allow another step of relative rotation between the spool and the driven member, the purpose of which is to unwind an increment of cutting string from the spool and allow the free extremity of the cutting string to extend out of the confines of the driven member between the posts 45 or 70 to provide a longer cutting surface for the rotary cutting assembly. This will replace any portion of the cutting string which has been broken off due to wear, fatigue, or impact with solid objects in the cutting operation.

Whenever it is desired to disassemble the driven member for replacement of the spool, the posts 70 will be deflected, releasing the notched surfaces 72 from the sides of the apertures 42 in the plate member 130 and permitting separation and removal of the plate member 132 therefrom. Thereafter, the spool 80 and the hub 90 integral therewith will be lifted off of the hub 140 and new cutting line may be mounted thereon or a replacement unit with cutting string thereon may be inserted in its place. Thus, no separate or special tools will be required for assembly or disassembly of the driven member for replacement of the spool or the addition of cutting string thereon. The posts 45 and 70 also serve as a supporting surface for the free end of the line from the spool which is extended by centrifugal force upon rotation of the head directing the cutting string out from the driven member between the posts in a conventional manner. Where the extended portion of a cutting string is broken upon impact or fatigue, the user of the rotary cutting assembly while rotating need only press the entire assembly against a surface causing the hub through its contact with the surface to overcome the compression of the spring 100 and move the spool assembly out of engagement with one set of ratchet teeth and into engagement with the other. Upon lifting or releasing of the rotary cutting assembly away from the surface, the spring will return the spool assembly within the driven member and against the plate member 132 allowing another increment of rotary movement between the spool assembly and driven member to complete the advance or automatic feed of an increment of cutting string from the spool through the action of centrifugal force on the line rotating the spool relative to the housing

In operation, several advantages of the apparatus and method of the invention are achieved. The abrasives of the preferred cutting string produce a plurality of cutting surfaces and air voids about the exterior surface of the string. The non-smooth exterior surface of the preferred cutting string results in several advantages. For example, the plurality of cutting surfaces produced by the abrasives of the preferred cutting string improves the cutting efficiency of the string. More particularly, the cutting surfaces of the preferred cutting string contribute to the ability of the string to cut grass, weeds and the like. Unlike conventional smooth surface cutting strings which rely almost solely upon the rotational velocity and force of impact of the string to cut grass, weeds and the like, the preferred cutting string of the invention relies on the cutting surfaces produced by the abrasives as well as the rotational velocity and impacting force of the cutting string to cut grass, weeds and the like. The result of the plurality of cutting surfaces on the preferred cutting string is that the cutting efficiency of the preferred cutting string is increased, the rotational velocity of the preferred cutting string need not be as high as the rotational velocity of a conventional smooth surface cutting string in order to cut the same grass, weeds or the like, the amount of stress imparted upon the rotary string trimmer with which the cutting string is used is decreased, the preferred cutting string cuts grass, weeds and the like up to 40% faster than conventional smooth surface strings, and the preferred cutting string is capable of cutting grass, weeds and the like that are up to ten times larger than the grass, weeds and the like that conventional smooth surface cutting strings are capable of cutting.

The plurality of air voids produced by the abrasives of the preferred cutting string also produce several advantages. For example, the air voids of the preferred cutting string have a cooling effect upon the string as it is rotated such as by a rotary string trimmer. The cooling effect of the air voids reduces the likelihood that the preferred cutting string will melt or fuse under high temperature conditions. Consequently, repairs and replacements of the preferred cutting string are reduced as compared to conventional smooth surface cutting strings. As a result, the preferred cutting string is less expensive and less time-consuming to repair and requires less frequent replacement.

The preferred cutting string of the invention will also have a longer lifespan than the conventional cutting string. As discussed above, the preferred cutting string may be exposed to an acidic substance during the manufacturing process. While the acidic substance is used to soften the preferred cutting string for application of the abrasive material, it is believed that the acidic substance will also produce a stronger, more resilient cutting string which will withstand greater forces without damage as compared to conventional cutting strings. Consequently, the preferred cutting string will resist breaking better than conventional cutting strings, and it will have a longer lifespan than conventional strings. As a result, the preferred cutting string is less expensive and less time-consuming to maintain, repair and replace than conventional strings.

The methods of making the preferred cutting string also achieve several advantages. For example, the preferred methods provide a simple and inexpensive way to manufacture the preferred cutting string.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, as would be understood and appreciated by a person having ordinary skill in the art to which the invention relates.

We claim:

1. A spool for a rotary string trimmer having an abrasive cutting string wound thereon and being mounted in a rotary cutting assembly of said string trimmer for incremental extension of at least one extremity of the cutting string, said cutting string comprising a thermoplastic core free of abrasive particles surrounded by an external layer in which abrasive particles are partially embedded so that portions of the abrasive particles protrude from the string.

2. The spool of claim 1 wherein the abrasive is fine foundry sand.

3. The spool of claim 1 wherein the profile of the cutting string is substantially circular.

4. The spool of claim 1 wherein the profile of the cutting string is selected from the group of oval, crescent, semicircular, triangular, rectangular, and polygonal shapes.

5. The spool of claim 1 wherein the thermoplastic core is nylon.

6. The spool of claim 1 wherein protruding portions of the abrasive particles substantially cover the surface of the string.

7. The spool of claim 1 wherein the portions of the abrasive particles protruding from the string provide a plurality of cutting edges.

8. The spool of claim 1 wherein spaces between protruding portions of the abrasive particles form cooling air voids upon movement of the string.

9. A spool for a rotary string trimmer having an abrasive cutting string wound thereon and being mounted in a rotary cutting assembly of said string trimmer for incremental extension of at least one extremity of the cutting string, said cutting string comprising a thermoplastic core free of abrasive particles surrounded by an external layer in which abrasive particles are partially embedded so that portions of the abrasive particles protrude from the string and protruding portions of the abrasive particles substantially cover the surface of the string.

10. The spool of claim 9 wherein the abrasive is fine foundry sand.

11. The spool of claim 9 wherein the profile of the cutting string is substantially circular.

12. The spool of claim 9 wherein the profile of the cutting string is selected from the group of oval, crescent, semicircular, triangular, rectangular, and polygonal shapes.

13. The spool of claim 9 wherein the thermoplastic core is nylon.

14. The spool of claim 9 wherein the portions of the abrasive particles protruding from the string provide a plurality of cutting edges.

15. The spool of claim 9 wherein spaces between protruding portions of the abrasive particles form cooling air voids upon movement of the string.

16. A spool for a rotary string trimmer having an abrasive cutting string wound thereon and being mounted in a rotary cutting assembly of said string trimmer for incremental extension of at least one extremity of the cutting string, said cutting string comprising a thermoplastic core free of abrasive particles surrounded by an external layer in which abrasive particles are partially embedded so that portions of the abrasive particles protrude from the string and the protruding portions provide a plurality of cutting edges.

17. The spool of claim 16 wherein the abrasive is fine foundry sand.

18. The spool of claim 16 wherein the profile of the cutting string is substantially circular.

19. The spool of claim 16 wherein the profile of the cutting string is selected from the group of oval, crescent, semicircular, triangular, rectangular, and polygonal shapes.

20. The spool of claim 16 wherein the thermoplastic core is nylon.
